(19) United States
(12) Patent Application Publication
(10) Pub. No.: US 2005/0267764 A1
(43) Pub. Date: Dec. 1, 2005

(54) Vehicle providing support method

(76) Inventor: Tateo Uegaki, Sendai-shi (JP)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/517,183

(22) PCT Filed: Jun. 9, 2003
(86) PCT No.: PCT/JP03/07292

§ 371 Date: Jul. 25, 2005

(30) Foreign Application Priority Data
Jun. 7, 2002 (JP) 2002-167674

(51) Int. Cl. G06F 17/60

(52) U.S. Cl. 705/1

(57) ABSTRACT

The present invention relates to a vehicle provision support technique for a customer and an object of the present invention is to provide a vehicle provision support method that is capable of improving the environment and vitalizing the used car market. A computer executes a step of presenting a plurality of repair items, a step of accepting selection of repair items of repairs to be performed to the vehicle, a step of outputting to a service center terminal work items needed for the repairs, based on the repair items accepted, a step of presenting information, before outputting the work items, the information as a judgement criterion for determining whether or not to make the repairs, a step of accepting judgement by the customer, and a step of determining whether or not to output the work items needed for the repairs, based on the judgement accepted.

### TECHNICAL FIELD

The present invention relates to a technique of supporting vehicle provision to a customer. More specifically, the present invention relates to a vehicle provision support method, a vehicle provision support program, and a vehicle provision support system for performing support to perform repairs meeting requirements of the customer on a vehicle and provide the vehicle to the customer.

### BACKGROUND ART

A vehicle provision sales method that is employed in a sales system for used cars is known as a vehicle provision method.

With this vehicle provision sales method, vehicles that become unnecessary due to being traded in for a new vehicle, or the like, are purchased by used car dealers. The purchased vehicles are then sold as used cars at used car dealerships.

According to research by the inventors of the present invention, it was found that there are much needs to be improved in this type of used car sales system.

First, a supply amount of vehicles that is to be supplied as used cars is saturated at present. Securing vehicles having a high market value (relatively good vehicles) is a priority in the used car marketplace. Thus, vehicles having a low market value, such as vehicles having excessive mileage and vehicles of older models, are not often sold at the used car dealerships. Furthermore, the majority of such vehicles tend to be scrapped. That is, when considering influence on the environment cannot exactly be said as being conventional used car sales methods are preferable.

Further, in recent years, along with the expansion of the used car marketplace, it has become easier to trade in vehicles, and vehicles are being placed on the used car market even if they have no problems. A phenomenon has therefore developed in which vehicles whose market value has dropped due to oversupply of vehicles are being thrown on the scrap heap while the prices of vehicles having a high market value are sharply running-up.

Accordingly, a novel vehicle provision method is becoming necessary as a substitute for the conventional used car sales techniques when considering the environmental problems described above and price stability on the used car market.

On the other hand, when looking at the usage state of computers in used car sales, only routine utilization occurs, such as storing an inventory of used cars and the market value of the vehicles into a database.

The present invention has been made in consideration of the background described above. An object of the present invention is to provide a vehicle provision support method, a vehicle provision support program, and a vehicle provision support system that enable improvement of the environment and vitalization of the used car market with ease.

Further, an object of the present invention is to provide a technique of accurately deriving latent demands a customer toward a vehicle.

### DISCLOSURE OF THE INVENTION

The present invention provides a vehicle provision support method for performing support using a computer to perform repairs on a vehicle and to provide the vehicle to a customer, characterized by including causing the computer to execute: a step of presenting a plurality of repair items to the customer; a step of accepting selection of repair items of repairs to be performed on the vehicle; a step of outputting work items needed for the repairs, based on the repair items accepted; a step of presenting information to the customer, before outputting the work items, the information being used as a judgement criterion for determining whether or not to make the repairs; a step of accepting judgement which is made by the customer after receiving the information used as the judgement criterion; and a step of determining whether or not to output the work items needed for the repairs, based on the judgement accepted.

With the vehicle provision support method of the present invention thus configured, a plurality of repair items are presented to a customer, and a repair item selected from among the plurality of repair items is accepted. Further, information used as a judgement criterion for determining whether or not to make repairs is presented to the customer. The judgement of the customer who has been provided with the information used as the judgement criterion is accepted. It is then determined whether or not to output work items needed for the repairs, based on the judgement.

That is, the selection of repair items is accepted with this vehicle provision support method. Further, information helpful in judging whether or not to carry out repair work is presented to the customer. Instructions for the repair work are issued when it is necessary to carry out the repair work. The repairs of the repair items selected by the customer are therefore carried out during vehicle provision, and it is thus possible to provide a vehicle that meets the needs of the customer. Accordingly, if the vehicle to be repaired is a used car, its market value can be increased without being restrained by the actual market value of the vehicle. Further, if the vehicle to be repaired is of the customer's own vehicle, the vehicle is reborn as one with added value due to the repairs, and the period of time during which the vehicle is in possession of the customer can be extended. As a result, the market value of each vehicle increases, and further, the oversupply of used cars can be controlled. The used car marketplace can thus be vitalized.

It should be noted that “repair” used in the present invention is the generic term for operations that impart added value to a vehicle. The following can be given as examples of repairs: fitting parts to the vehicle; exchanging specified parts; fixing defective portions; performing various types of coatings; performing interior maintenance; setting service items for the vehicle; and performing part conversion.

Further, it is preferable that information that contains one of working time needed for the repairs and costs needed for the work is presented in the step of presenting the information used as the judgement criterion.

An amount of time required for repairs, a cost for the repairs, and the like are displayed to the customer with this configuration as helpful information for determining whether or not to make repairs.

Further, it is also possible that the plurality of repair items are divided in advance into groups on a clientele basis and selection of the repair items is accepted with the group taken as a unit when accepting the selection of the repair items in the step of accepting the selection of the repair items.

The repair items are divided (classified) into groups on the clientele basis with this configuration. It therefore becomes possible to have uniform repair item selection by selecting a group, even for customers who lack knowledge relating to repairs. It should be noted that “clientele” is the term specified by objective determination on the basis of the given judgement criteria of age, sex, and standard of living.

Further, it is also possible that when the repairs are performed and the repaired vehicle is delivered to the customer, the computer further executes: a step of acquiring a date on which the vehicle is delivered; a step of computing a fixed date after a predetermined period of time has passed from the vehicle delivery date as a warranty period expiration date; and a step of displaying the computed warranty period expiration date.

With this configuration, the customer has the security of knowing the date of expiration of a warranty period can be displayed to the customer. It should be noted that “predetermined period” means a warranty period that is uniformly computed regardless of the number of repair items, warranty periods determined for each repair item, or the like, and it is possible to set the “predetermined period”.

Further, it is also possible that the computer is connectable to a database capable of storing repair items accepted in the past and information on customers selecting the repair items in association with each other, and that
when the step of presenting the repair items is performed for a new customer, the computer executes: a step of reading in information on the new customer; a step of extracting information on customers which is similar to the information of the new customer; and a step of presenting repair items to the new customer, the repair items being associated with the extracted customer information.

Past selections are associated with information on the customers who have made the selections with this configuration, and stored in a database. When repair items are presented to a new customer, information on the new customer is checked against the information stored in the database, and repair items that are assumed to be close to the demands of the new customer are extracted from the database. The extracted repair items are then presented to the new customer. It therefore becomes possible to present the repair items close to the demands of the new customer.

Further, it is also possible that when apart is to be installed in the vehicle during the repairs, the computer further executes: a step of accepting a judgement as to whether or not the part is to be installed as a leased item; and a step of computing and presenting costs needed for leasing the part when the part is to be installed as the leased item in the step of accepting the judgement.

Verification is made as to whether or not a part is a leased part when installing parts to a vehicle according to a repair with this configuration. Costs required for leasing the part a recomputed and presented to the customer when there is a request to install the part as a leased part. Repairs can therefore be made at a relatively low cost.

The present invention further provides the following vehicle provision support program.

More specifically, the present invention provides a vehicle provision support program for causing a computer to execute support for performing repairs on a vehicle, and for providing the vehicle to a customer, the computer executing: a step of presenting a plurality of repair items to the customer; a step of accepting selection of repair items of repairs to be performed on the vehicle; a step of outputting work items needed for the repairs, based on the repair items accepted; a step of presenting information to the customer, before outputting the work items, the information being used as a judgement criterion for determining whether or not to make the repairs; a step of accepting judgement which is made by the customer after receiving the information used as the judgement criterion; and a step of determining whether or not to output the work items needed for the repairs, based on the judgement accepted.

The present invention further provides the following vehicle provision support system.

Specifically, the present invention provides a vehicle provision support system for performing support to perform repairs on a vehicle and to provide the vehicle to a customer, including: repair item presentation means for presenting a plurality of repair items to the customer; repair item accepting means for accepting selection of repair items of repairs to be performed to the vehicle; a work item outputting means for outputting work items needed for the repairs, based on the repair items accepted; judgement criterion presentation means for presenting information to the customer, before outputting the work items, the information being used a judgement criterion for determining whether or not to make the repairs; repair judgement accepting means for accepting judgement which is made by the customer after receiving the information used as the judgement criterion; and output determination means for determining whether or not to output the work items needed for the repairs, based on the judgement accepted.

It should be noted that the configuration of the vehicle provision support system of the present invention is not limited to only one computer. For example, a system configuration is also applicable in which multiple computers are connected through a network, and functions required for the vehicle provision support system of the present invention are achieved by sharing the functions between the computers. It should be noted that in this case a vehicle can be provided, which conforms to the demands the customer over a wide range with the minimum configuration by allocating the functions required at the computer installation location to each of the computers.

According to the present invention, sufficient added value that fulfills the needs of the customer can also be given to vehicles having a low market value. Further, the holding period of the vehicle can be lengthened, and therefore increases in the price of specific vehicles can be avoided, as can oversupply of used cars. As a result, the used car marketplace is thus vitalized.

Furthermore, acquisition and shipment of the vehicle for repairs, and arrangement of materials, parts and the like needed for repairs are managed promptly after receiving the request for repairs according to data processing between terminals. The customer therefore is not kept waiting longer than necessary.

### BRIEF DESCRIPTION OF THE DRAWINGS

FIG. 1 is a schematic structural diagram of a vehicle provision support system according to the present invention.

FIG. 2 is a schematic structural diagram of a terminal used in the vehicle provision support system according to the present invention.

FIG. 3 is a flowchart that shows processing procedure of a vehicle provision support program according to the present invention, in a dealer terminal.

FIG. 4 is a schematic structural diagram of an initial screen image that is displayed by starting up the vehicle provision support program according to an embodiment of the present invention.

FIG. 5 is a schematic structural diagram of a group selection screen image that is displayed after the initial screen image shown in FIG. 4.

FIG. 6 is a schematic structural diagram of a confirmation screen image that is displayed according to a “young” dialog operation in FIG. 5.

FIG. 7 is a schematic structural diagram of a confirmation screen image that is displayed according to a “female” dialog operation in FIG. 5.

FIG. 8 is a schematic structural diagram of a confirmation screen image that is displayed according to a “middle-aged female” dialog operation in FIG. 5.

FIG. 9 is a schematic structural diagram of a confirmation screen image that is displayed according to a “middle-aged male” dialog operation in FIG. 5.

FIG. 10 is a schematic structural diagram of a confirmation screen image that is displayed according to a “high grade” dialog operation in FIG. 5.

FIG. 11 is a schematic structural diagram that shows a screen image of items to be added of a repair group that relates to maintenance, the screen image being displayed according to an “option” dialog operation in FIG. 5.

FIG. 12 is a schematic structural diagram that shows a screen image of items to be added of a repair group that relates to an exterior, the screen image being displayed after the screen image of repair group items to be added in FIG. 11.

FIG. 13 is a schematic structural diagram that shows a screen image of items to be added of a repair group that relates to an exterior, the screen image being displayed after the screen image of repair group items to be added in FIG. 12.

FIG. 14 is a schematic structural diagram that shows a screen image of items to be added of other repair group, which is displayed after the screen image of repair group items to be added in FIG. 13.

### BEST MODE FOR CARRYING OUT THE INVENTION

A vehicle provision support method, a vehicle provision support program, and a vehicle provision support system according to the present invention, and an embodiment of incorporating those techniques into a used car sales business are explained.

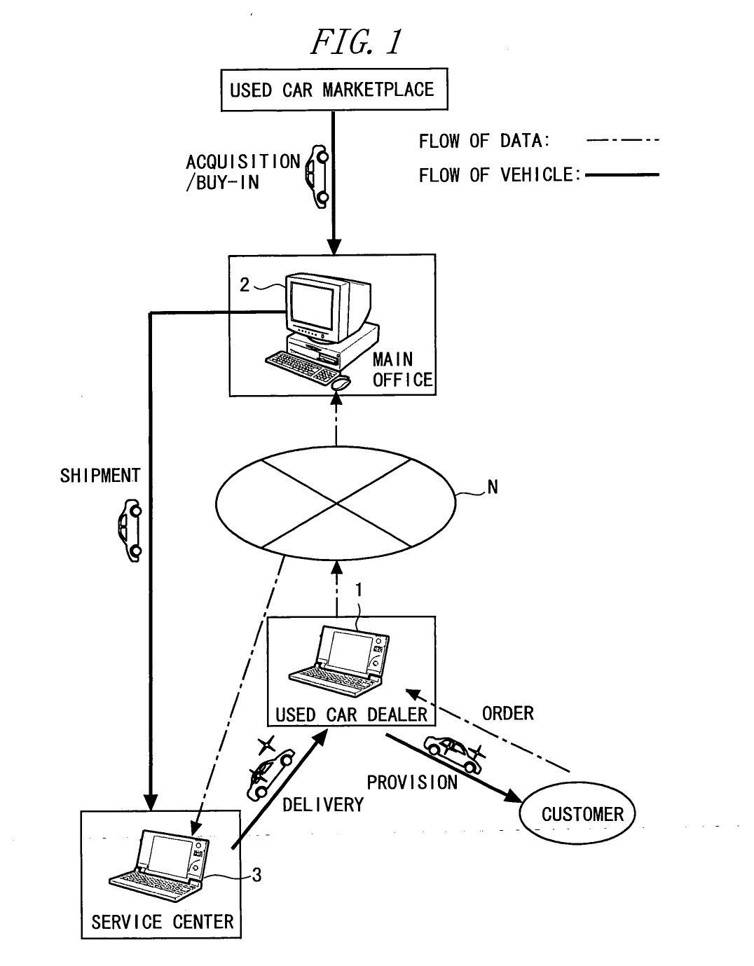

Referring to FIG. 1, a system configuration for achieving the vehicle provision support method of the present invention is explained first. It should be noted that a fine line (dashed line) in FIG. 1 shows a flow of data (transmission/reception) that takes place between terminals on the system. Further, a bold line (solid line) in FIG. 1 shows a flow (movement) of vehicles in accordance with data processing by the system.

As shown in FIG. 1, the system configuration shown in this embodiment includes a dealer terminal 1 that is installed at a used car dealership (hereinafter referred to as a dealer), a main office terminal 2 that is installed at a main office for performing procurement of used cars, arrangements, and the like, and a service center terminal 3 that is installed at a service center that performs repairs. Further, the terminals 1, 2, and 3 are mutually connected together through a general-purpose network or through a dedicated network.

Further, in addition to an operating system (OS) W for operating the terminal, a vehicle provision support program S for making the terminals 1, 2, and 3 function as computers of the vehicle provision support system of the present invention is also installed at each of the terminals 1, 2, and 3. Furthermore, used cars are distributed between the main office, the service center, and the dealer based on data sent and received between each of the terminals 1, 2, and 3, data transmission and reception accompanying execution of the vehicle provision support program. The used cars are provided to customers after performing repairs that conform to orders placed by customers.

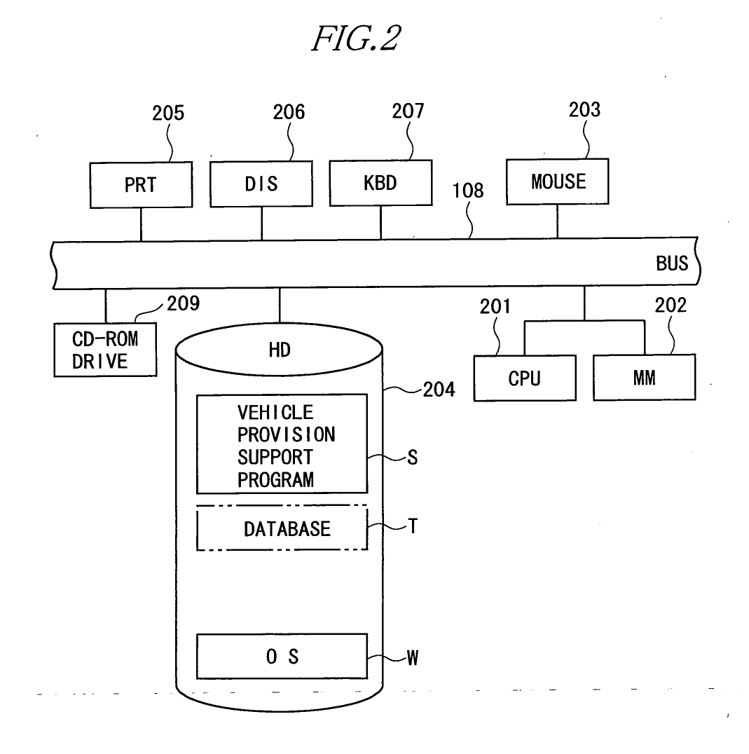

It should be noted that the terminals 1, 2, and 3 are general-purpose terminals. As shown in FIG. 2, for example, each of the terminals 1, 2, and 3 may include a CPU (central processing unit) 201, a memory 202 such as a ROM (read only memory) or a RAM (random access memory) that is connected to the CPU 201, and a HD (hard disk) 204 that is connected to the CPU 201 and to the memory 202 through a bi-directional bus 208.

Further, input devices such as a keyboard 207 and a mouse 203, a display 206 that displays processing results that accompany execution of various processings, a printer 205 for printing the processing results, and the like are provided as external devices.

Further, the HD 204 stores the operating system (OS) W and the vehicle provision support program S according to the present invention. Still further, a database T necessary for various processings is constructed according to the specifications of each of the terminals. The CPU 201 executes the vehicle provision support program under operation of the operating system W, and data is sent and received between each of the terminals 1, 2, and 3. Furthermore, the program is read in from a CD-ROM drive 209 or the like provided to the terminals, and stored in the HD 204.

It should be noted that, in this embodiment, the terminals installed at the main office, the service center, and the dealer, and the vehicle provision support program introduced to the terminals, configure a system for achieving the vehicle provision support method. Further, various steps and various functions in the present invention are achieved by executing various processings that are processed within the vehicle provision support system.

The terminals 1, 2, and 3 are discussed in detail below.

First, the dealer terminal 1 that is installed at the dealer has main functions for sending the content of an order as data from a used car purchaser (hereinafter referred to as a customer) to the main office terminal 2 and the service center terminal 3. The functions are achieved by executing the vehicle provision support program that has been introduced into the dealer terminal 1. It should be noted that the vehicle provision support program is discussed later in detail.

Further, the main office terminal 2 that is installed at the main office is a server for storing vehicle information on used cars distributed on the used car market and information on vehicles themselves that are stocked as used cars. Acquisition and stocking of vehicles that distribute on this system are managed as data by data exchange (transmission/reception) between the main office terminal 2 and the dealer terminal 1. Furthermore, the main office terminal 2 is provided with a database that stores vehicle information such as the type of vehicle, the location of the vehicle, and the vehicle price.

It should be noted that the vehicle information stored in the database is updated serially, and the latest vehicle information can be quickly and accurately searched at any given time. It should also be noted that the data updating of the vehicle information, and the transmission and reception of data to and from the dealer terminal 1 are processed by executing the vehicle provision support program that is introduced into the main office terminal 2.

On the other hand, the service center terminal 3 that is installed at the service center has functions for displaying work items based on the order placed by the customer at the dealer. Repair workers proceed with the repair work based on the work items that are output to the service center terminal 3. It should be noted that the work items that must be output are extracted from the database T used for the work items and constructed on the HD 204 of the dealer terminal 1. The service center terminal 3 displays the work items on a display 206 after receiving data on the work items from the dealer terminal 1. Further, the display of the work items (output) and the reception of the data from the dealer terminal 1 are processed by executing the vehicle provision support program that is introduced into the service center terminal 3.

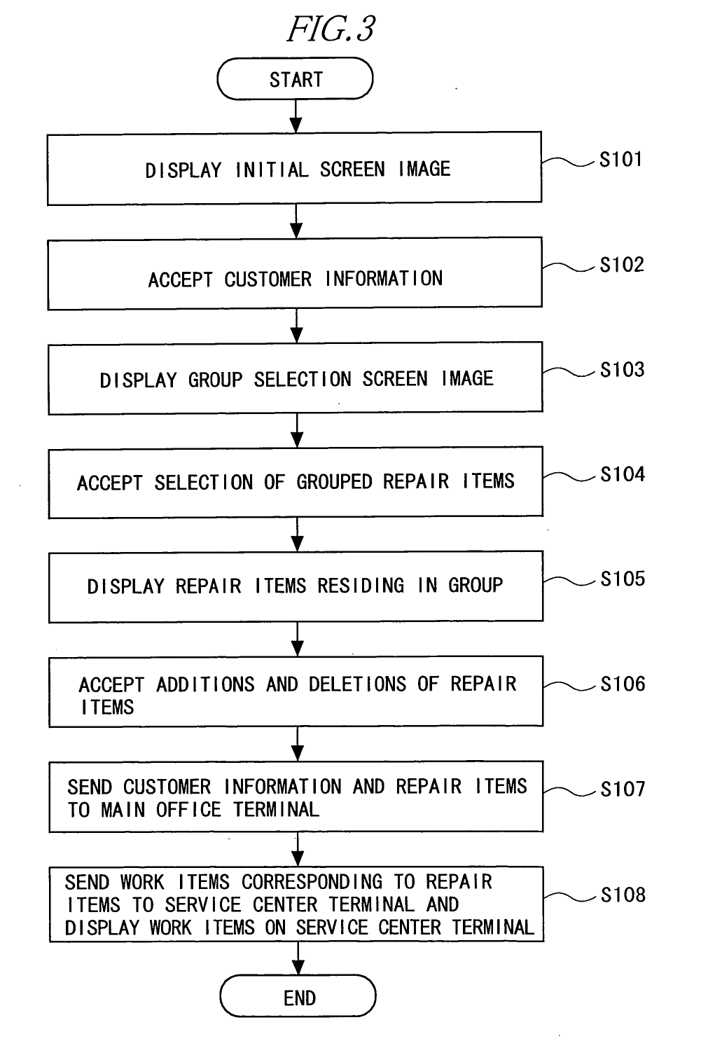

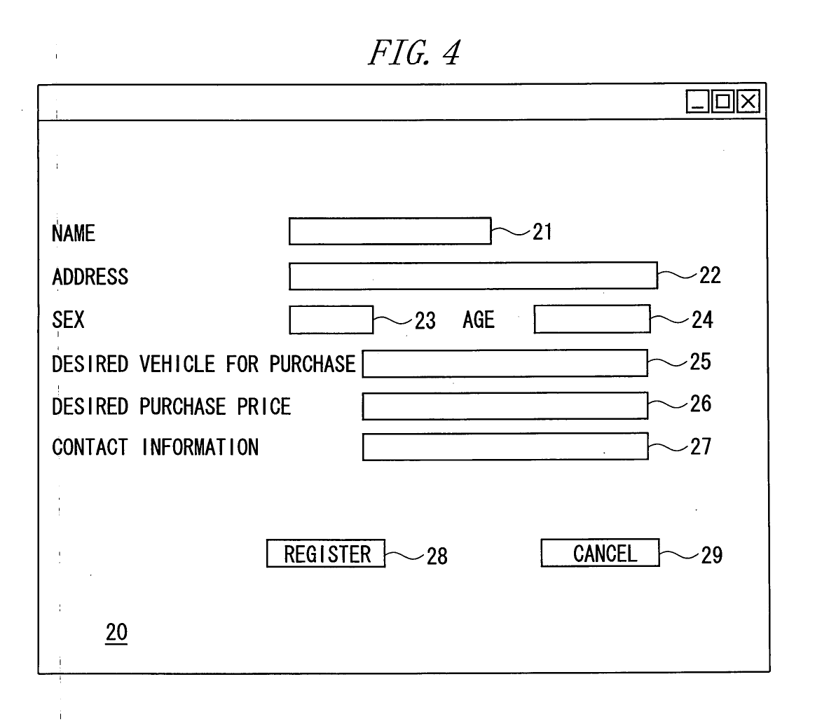

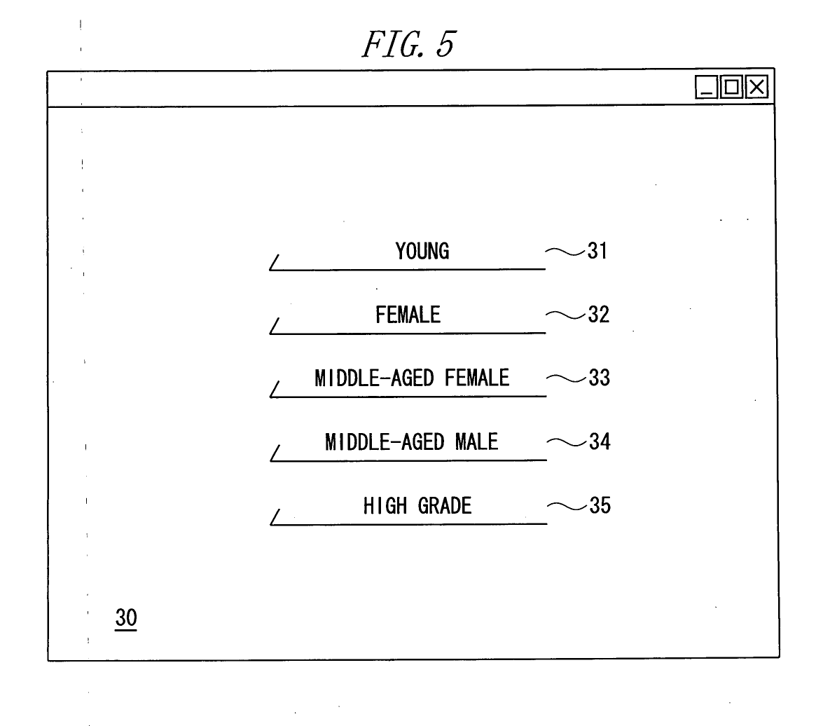

Next, the flow of data on the system described above is explained based on vehicle distribution steps. It should be noted that FIG. 4 to FIG. 14 are screen images that are displayed on the display 206 of the dealer terminal 1 in executing the vehicle provision support program that is introduced into the dealer terminal 1. Further, FIG. 3 is a flowchart that shows a series of flow for each process that is processed within the dealer terminal 1.

First, an initial screen image 20 shown in FIG. 4 is displayed on the display 206 of the dealer terminal 1 following startup of the vehicle provision support program that is stored in the dealer terminal 1 (S101).

An input form for inputting information on a customer who is a used car purchaser is displayed in the initial screen image 20. More specifically, a blank space 21 for inputting the name of the customer, a blank space 22 for inputting the address of the customer, a blank space 23 for inputting the sex of the customer, a blank space 24 for inputting the age of the customer, a blank space 25 for inputting the type of vehicle desired for purchase, a blank space 26 for inputting the desired purchase price, a blank space 27 for inputting the contact information of the customer (a telephone number, for example), a registration dialog 28 for reflecting the input items to the vehicle provision support program processings, an erasure dialog 29 for erasing the input items, and the like are displayed. It should be noted that the input items shown here are merely examples, and various input items can also be added as desired.

After the customer or a dealer employee inputs the customer information based on the input form, the registration dialog 28 is clicked, and the customer information is accepted by the dealer terminal 1 (S202). The vehicle provision support program that is stored in the dealer terminal 1 causes a group selection screen image 30 (refer to FIG. 3) to be displayed on the display 206 (S103).

Choices for repair (hereinafter referred to as a group) to be made on the vehicle desired for purchase are displayed in the group selection screen image 30. It should be noted that the repair items are sorted into groups based on clientele types of “young”, “female”, “middle-aged male”, “middle-aged female”, and “high grade”. The customer refers to names attached to dialogs 31 to 35 for each of the groups, and selects a group for the desired repairs. It should be noted that, as a group specification method, it is possible to make a specification by clicking on the dialogs 31 to 35 that are provided for each of the groups. The dealer terminal 1 accepts the group selection in accordance with the operations performed on the dialogs 31 to 35 (S104).

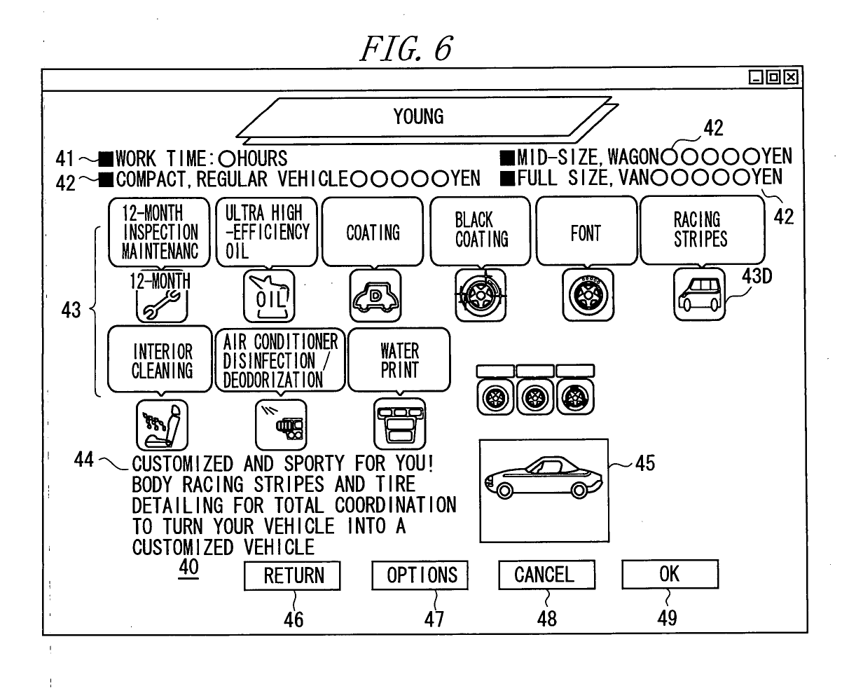

Next, the dealer terminal 1 displays details on the selected group on the display 206 (S105). It should be noted that FIG. 6 to FIG. 10 are screen images that show details on each group, that is, specific repair item groups set for each of the groups. For example, when a group corresponding to “young” is specified, a confirmation screen image 40, to which repair items intended for young people are allocated, is displayed on the display 206 (refer to FIG. 6).

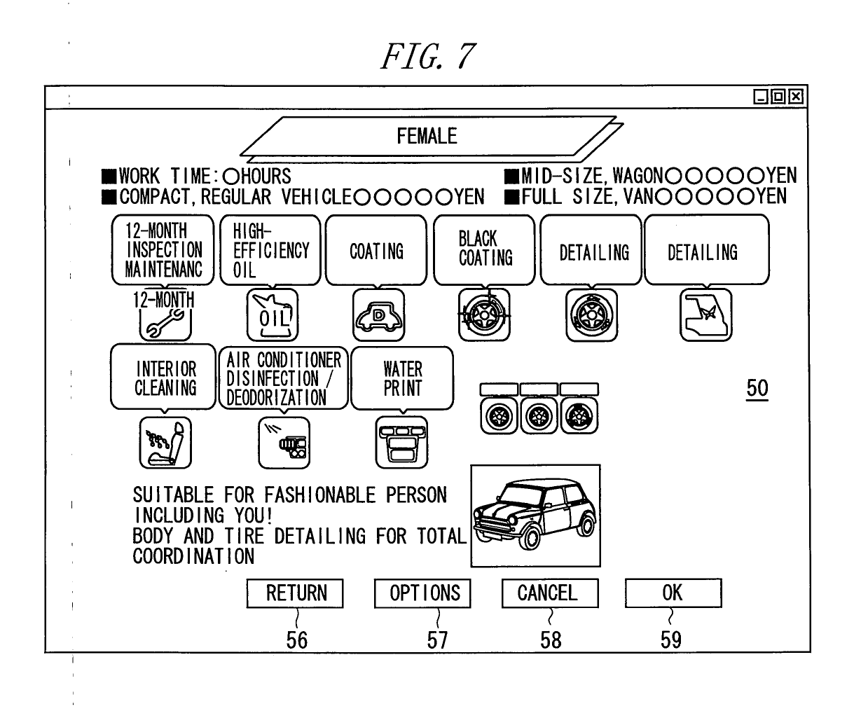

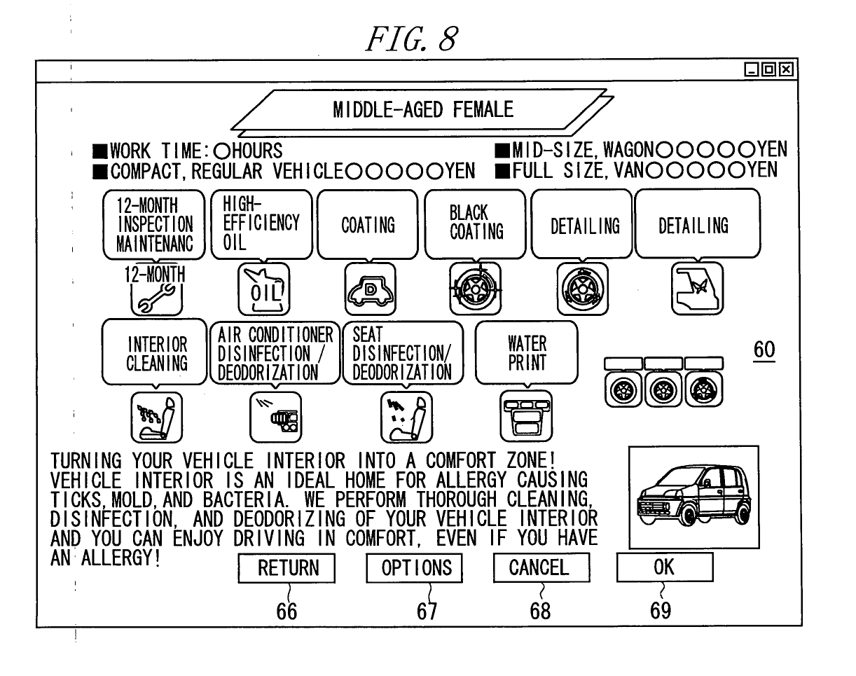

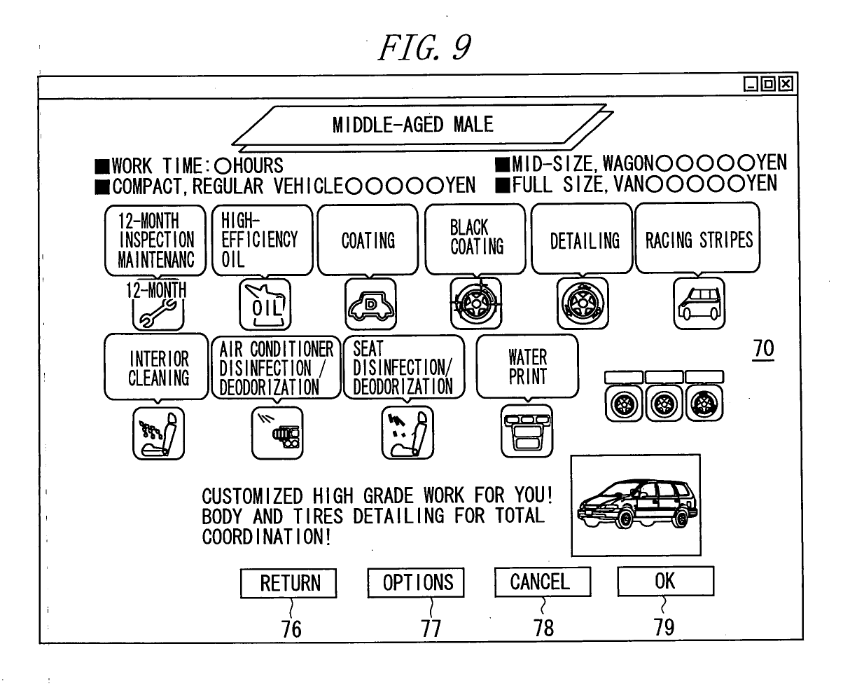

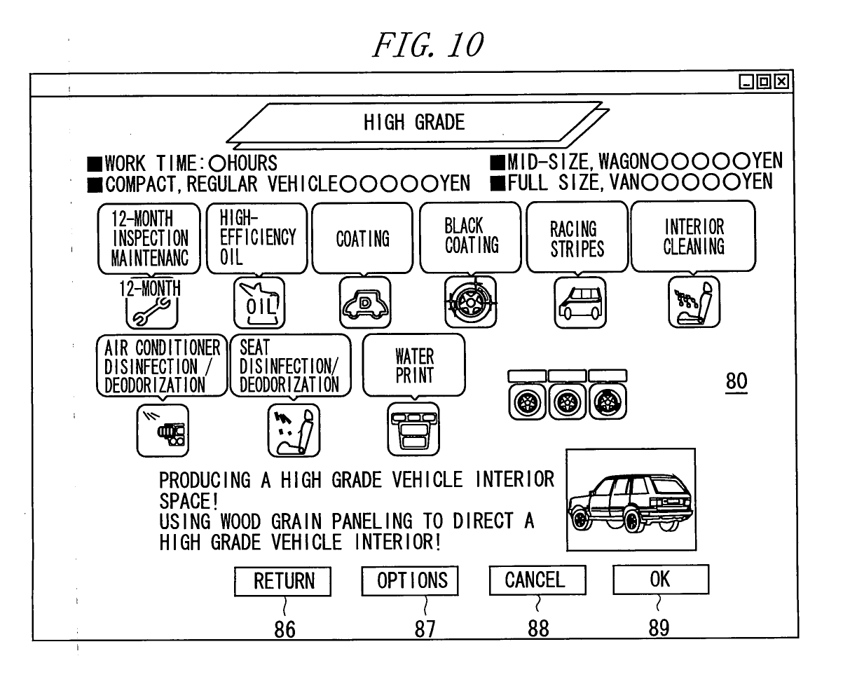

Further, a confirmation screen image 50, to which repair items intended for females are allocated, is similarly displayed when a group corresponding to “female” is specified (refer to FIG. 7), and a confirmation screen image 60, to which repair items intended for middle-aged males are allocated, is displayed when a group corresponding to “middle-aged male” is specified (refer to FIG. 8). Further, a confirmation screen image 70, to which repair items intended for middle-aged females are allocated, is displayed when a group corresponding to “middle-aged female” is specified (refer to FIG. 9), and a confirmation screen image 80, to which repair items intended for high grade customers are allocated, is displayed when a group corresponding to “high grade” is specified (refer to FIG. 10).

It is possible to make changes to, and confirmation of, the repair items for the vehicle desired for purchase with the confirmation screen images 40 to 80. A method of setting the repair items by using the vehicle provision support program is explained below with reference to the confirmation screen image 40 for “young” (group) shown in FIG. 6. It should be noted that screen arrangements of the other confirmation screen images 50 to 80 are pursuant to the confirmation screen image 40 shown in FIG. 6. Thus, the explanation of the confirmation screen image 40 is made herein and explanations of the confirmation screen image 50 to the confirmation screen image 80 are omitted.

First, a region 41 for displaying an amount of work time needed for repairs, regions 42 for displaying costs needed for repairs, by vehicle type, a list display 43 of items of repair to be made on the vehicles, a region 44 for displaying the trend of the group, and a region 45 for displaying a vehicle that is already repaired are secured in the confirmation screen image 40 that is displayed when a group for “young” is selected. It should be noted that the screen arrangements for the other confirmation screen images 50 to 80 are similar.

Further, display aspects described below can be exemplified for the specifics of each region.

First, the total amount of work time needed to make the repairs allocated is shown in the region 41 for displaying the work time needed for repairs. Further, the respective repair costs are displayed in the regions 42 for displaying the costs needed to make repairs by vehicle types grouped into “mid-size, wagon”, “compact, normal vehicle”, and “full size, van”.

Furthermore, comments on features of repairs are displayed in the region 44 for displaying the trend of the group. Still further, a sample image of the vehicle after being repaired is displayed in the region 45 for displaying a vehicle that is already repaired. It should be noted that the display aspects of each region may of course differ according to the group selected. Further, the dialog of the region 43 that displays the list of repair items is discussed later in detail.

Furthermore, “return”, “option”, “cancel”, and “OK” dialogs are displayed at the bottom of the screen (reference numerals 46 to 49 in FIG. 6). The “return” dialog 46 here is an operation region for returning the current screen to the previous screen. Further, the “cancel” dialog 48 is an operation region for returning deleted repair items and added repair items to an initial state of repair items. It should be noted that it is possible to perform specification of repair items to be deleted by clicking a dialog 43D for each of the repair items displayed in the confirmation screen image 40. Further, it becomes possible to add repair items by clicking the “option” dialog 47 when adding repair items. Still further, the “OK” dialog 49 is an operation region for registering the repair items that are confirmed by the customer confirmation with the dealer terminal 1.

Furthermore, the program is configured in this embodiment so that the display of the display regions 41 and 42, which are the work time and the costs needed for repairs, on the screen is changed whenever a repair item is added or deleted. More specifically, the work time and the cost for each repair is read out from the database T stored on the HD 20 of the dealer terminal 1 for each repair item that is added or deleted. In addition, the total work time and the total cost up to that time are multiplied by a coefficient determined according to vehicle type when repair items are added or deleted, and the results are redisplayed on the screen.

The dealer terminal 1 then accepts operations such as adding and deleting the repair items by operations of the customer or the dealer employee (S106). Further, the dealer terminal 1 ascertains a final confirmation of the repair items selected by the customer by the customer or the dealer employee clicking on the “OK” dialog 49, and the customer information input with the initial screen image 20 is sent along with the repair items selected in the step S106, and data required for scheduling and the like, to the main office terminal 2 (S107). Furthermore, the dealer terminal 1 reads out work items from the HD 204 based on the selected repair items, and the work items are sent to the service center terminal 3 and are displayed on the display 206 of the service center terminal 3 (S108).

Further, the main office terminal 2 retrieves the database T for the vehicle information based on the data received from the dealer terminal 1, and locates the vehicle type desired for purchase by the customer through this retrieval. Furthermore, the vehicle is acquired and secured based on the vehicle information located at the main office, and the vehicle is shipped the service center.

On the other hand, materials, parts, and the like that are needed for repairs are acquired at the service center with reference to the work items that are displayed in the service center terminal 3, before the vehicle is brought from the main office. Further, repairs are made on the vehicle according to the work items after the vehicle is shipped. The repaired vehicle is then handed over to the customer via a used car dealer, for example.

A plurality of groups can thus be presented to the customer with this type of system, and the selection of repair items is received with the groups taken as units. Furthermore, information that becomes a judgement criterion for determining whether or not to make repairs (for example, the amount of work time needed for the repairs, the costs needed for repairs according to vehicle type, and the like) is presented to the customer. The judgement made by the customer, to whom the judgement criterion information has been presented, is then received. The work items needed for repairs are then output to the service center terminal 3 based on the judgement.

That is, with the vehicle provision support method described in this embodiment, the selection of the repair items is accepted, and further, helpful information for judging whether or not to make the repair work is presented to the customer. The repair work is performed when the customer accepts the repair work. Acquisition and delivery of the vehicle, and acquisition of materials, parts, and the like needed for repairs are therefor processed quickly by data processing performed between each of the terminals. The customer is thus not kept waiting longer than necessary.

Further, repair of the repair items selected by the customer are performed on the vehicle, and therefore it becomes possible to provide a vehicle that conforms to the needs of the customer. Furthermore, the market value of the vehicle can be increased, without being held captive to the market value of the vehicle itself. As a result, even vehicles having a low market value can be distributed on the used car market. Accordingly, price stability can be achieved in addition to improvements in terms of the environment by controlling the scrapping of vehicles in the used car market.

Furthermore, in this embodiment, a plurality of repair items are grouped in advance according to clientele. The groups of repair items are then accepted as units when the repair items are selected. It therefore becomes possible for even a customer who is not knowledgeable about repairs to select repair items that provide commonality and is fashionable by selecting the group.

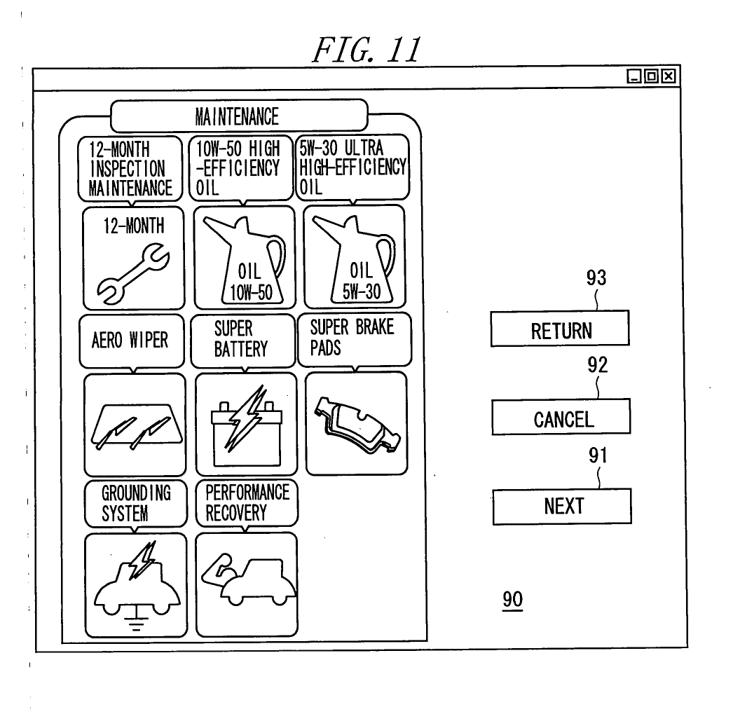

It should be noted that the repair items described above can be added by selecting the “option” dialog 47 shown in FIG. 6 to FIG. 10. The addition of repair items is explained below with reference to item addition screens (refer to FIG. 11 to FIG. 14) that are displayed by selecting the “option” dialog 47.

Dialogs corresponding to each repair item are displayed in the item addition screen, and it becomes possible to add new repair items in each group by clicking on the dialog. Further, detailed work items are specified in each of the repair items. The work items specified in the added repair items are also sent to the service center terminal 3 when the repair items are added. The work items are displayed on a screen of the service center terminal 3.

First, four repair groups are prepared as repair items in this embodiment: “maintenance”, “exterior”, “interior”, and “other”. Detailed repair items are allotted to each repair group. An item addition screen image 90 that is classified into the “maintenance” group is displayed first on the display 206 of the dealer terminal 1 when the “option” dialog 47 is clicked (refer to FIG. 11).

A total of 8 repair items that are classified into the “maintenance” repair group are displayed in the item addition screen image 90, as shown in FIG. 11. First, when a dialog with a display “12-month inspection maintenance” is selected, the 12 month inspection law is specified as work items to be output to the service center terminal 3. Similarly, when a “10W-50 high-efficiency oil” dialog is selected, an oil exchange with a high-efficiency oil specified by the dealer or the main office is specified as the work item. Further, when a “5W-30 ultra high-efficiency oil” dialog is selected, an oil exchange with ultra high-efficiency oil specified by the dealer or the main office is specified as the work item.

Furthermore, when an “aero wiper” dialog is selected, a fin attachment for stopping wiper vibration is specified. Still further, when a “super battery” dialog is selected, installation of a high performance battery specified by the dealer or the main office is specified. Even further, when a “super brake pad” dialog is selected, the installation of high performance brake pads specified by the dealer or the main office is specified.

Further, when a “grounding system” dialog is selected, the installation of a corrosion controlling device that prevents corrosion of a vehicle body is specified. Furthermore, when a “performance recovery” dialog is selected, engine performance recovery work in which internal portions of an engine are cleaned and accessories are replaced is specified.

Further, in addition to the dialogs relating to setting of the repair items described above, a “next” dialog 91 that is an operation region for issuing an instruction to switch to the next repair group, a “cancel” dialog 92 that is an operation region for resetting the selected repair items, and a “return” dialog that is an operation region for returning to the previous screen are displayed in the item addition screen image 90. The next processings start by operation of the dialogs 91, 92, and 93.

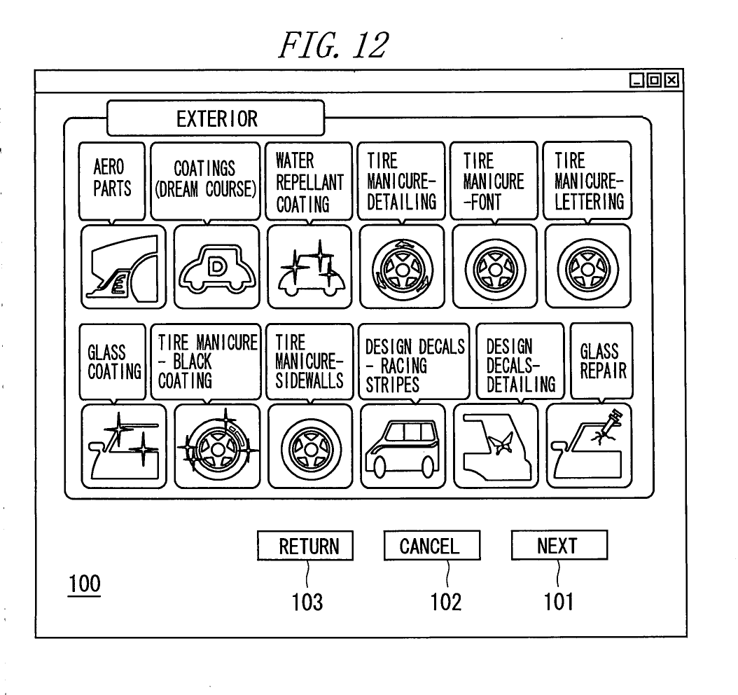

When the “next” dialog 91 within the item addition screen image 90 is operated, the addition of the repair items added on the item addition screen image 90 are performed, and an item addition screen image 100 is displayed (refer to FIG. 12).

Next, a total of 11 repair items that are classified into the exterior repair group are displayed in the item addition screen image 100, as shown in FIG. 10. First, when an “aero parts” dialog is selected, an auxiliary aero part known as a bumper spoiler is specified. Further, when a “coating” dialog is selected, polishing coating work by a coating method specified by the dealer or the main office is specified. Furthermore, when a “water repellant coating” dialog is selected, a water repellant coating by a water repellant coating method specified by the dealer or the main office is specified.

Further, when a “one point” dialog is selected, work for adding an illustration to tires is specified. Still further, when a “font” dialog is selected, work for adding arbitrary characters to the tires is specified. Even further, when a “letter” dialog is selected, work for coloring a tire marking (manufacturer's name, for example) is specified.

Further, when a “glass coating” dialog is selected, a water repellant coating is specified according to a coating method that is specified by the dealer or the main office. Still further, when a “black coating” dialog is selected, polishing work on the tires by a coating method specified by the dealer or the main office is specified. Even further, when a “sidewalls” dialog is selected, work for painting along sidewalls of the tires is specified.

Further, when a “racing stripe” dialog is selected, work for adding line shape decals to side surfaces of the vehicle body is specified. Furthermore, when a “one point” dialog is selected, work for attaching decals to vehicle body locations is specified. Still further, when a “glass repair” dialog is selected, glass repair work according to a repair method specified by the dealer or the main office is specified.

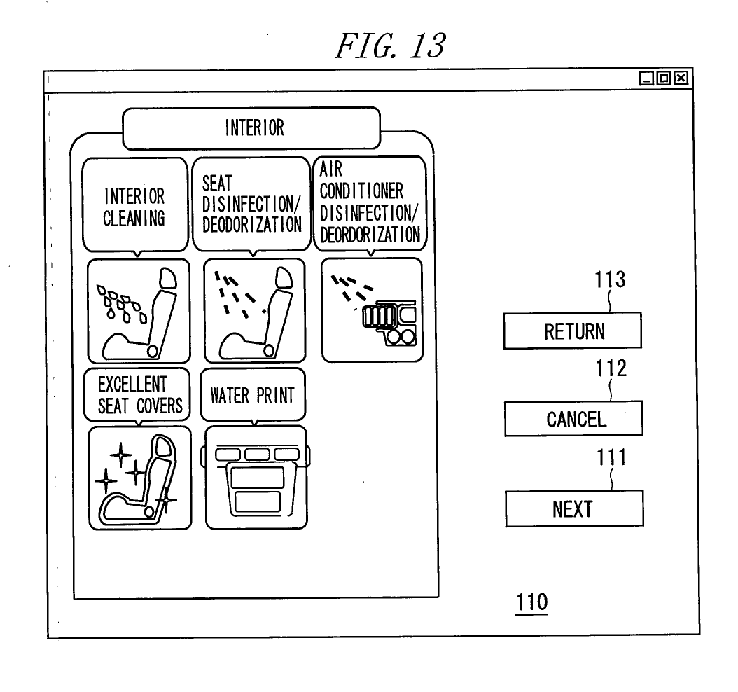

Further, as in the above, in addition to the dialogs relating to setting of the repair items described above, a “next” dialog 101 that is an operation region for issuing an instruction to switch to the next repair group, a “cancel” dialog 102 that is an operation region for resetting the selected repair items, and a “return” dialog 103 that is an operation region for returning to the previous screen are displayed in the item addition screen image 100. When the “next” dialog 101 is operated, the addition of the repair items already selected is performed and an item reservation screen image 110 is displayed (refer to FIG. 13).

Next, a total of 5 repair items that are classified into the interior repair group are displayed in the item reservation screen image 110, as shown in FIG. 13. First, when a “room cleaning” dialog is selected, interior cleaning work according a cleaning method specified by the dealer or the main office is specified.

Further, when a “seat disinfection/deodorization” dialog is selected, seat disinfection and deodorization work according to a disinfection and deodorization method specified by the dealer or the main office is specified. Furthermore, when an “air conditioner disinfection/deodorization” dialog is selected, air conditioner disinfection and deodorization work according to a disinfection and deodorization method specified by the dealer or the main office is specified. Still further, when an “excellent seat covers” dialog is selected, work for installing seat covers specified by the dealer or the main office is specified. Even further, when a “water print” dialog is selected, work for painting or transferring a design to a panel or the like by a painting method or a transferring method specified by the dealer or the main office is specified.

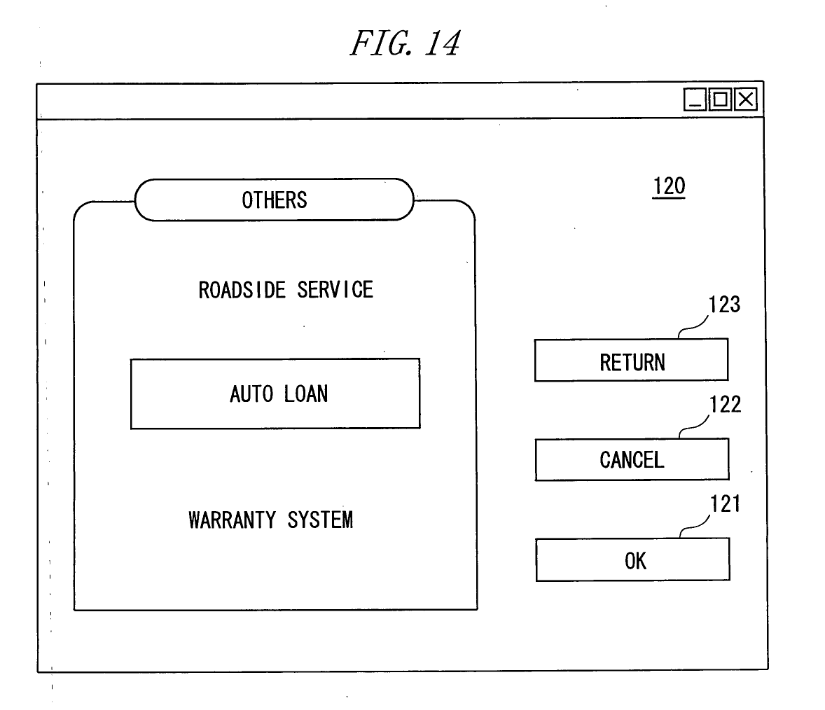

Further, similar to the above, in addition to the dialogs relating to setting of the repair items, the “next” dialog 111 that is an operation region for issuing an instruction to switch to the next repair group, the “cancel” dialog 112 that is an operation region for resetting the selected repair items, and the “return” dialog 113 that is an operation region for returning to the previous screen are displayed in the item reservation screen image 110. When the “next” dialog 111 is operated, the addition of the repair items already selected is performed and an item reservation screen image 120 is displayed (refer to FIG. 14).

A total of three repair items that are classified into the other repair group are displayed in the item specification screen image 120, as shown in FIG. 14. First, when a “road service” dialog is selected, road service by a road service company having a tie-up with the main office is included with the vehicle. Further, when an “auto loan” dialog is selected, financing by a financial institution having a tie-up with the main office is received, and purchase of the vehicle becomes possible. Furthermore, when a “warranty system” dialog is selected, a fixed period warranty (two years from the date of purchase, for example) is applied.

Further, in addition to a “cancel” dialog 122 that becomes an operation region for resetting the selection of the selected repair items, and a “return” dialog 123 that becomes an operation region for returning to the previous screen, an “OK” dialog 121 that becomes an operation region for reflecting the operations from the screen image 90 to the item specification screen image 120 are displayed in the item specification screen image 120. When the dialog 121 is operated, the display returns to the group confirmation screen (FIG. 6, for example).

High quality repairs can thus be provided in this embodiment because the repair work is performed according to the work items specified by the dealer and the main office. Further, the acquisition of materials, parts, and the like needed during repair is easy. Furthermore, multiple repair items are prepared, and in addition, it is possible to add or delete the repair items one by one, and therefore this embodiment can handle the wide ranging demands the customers.

It should be noted that the system configuration of the vehicle provision support method explained above is only a preferred embodiment. It is possible to change the details of the configuration as desired.

For example, for cases where a warranty service is added and a repaired vehicle is provided to the customer, the date of delivery of the vehicle may be read in by the dealer terminal 1. A fixed date after a predetermined period from the date of delivery of the vehicle may be computed as a warranty period expiration date and displayed in the confirmation screen images 40 to 80 and the like. In this case peace of mind can be provided to the customer because the warranty period expiration date is displayed to the customer.

Further, past selections are associated with information on the customer who has made the selections, and stored in the database. When repair items are presented to a new customer, information on the new customer is checked with information stored in the database. Repair items required by the new customer may be estimated, and the estimated repair items may be presented to the new customer. In this case it becomes possible to present a group that is close to the demands of the new customer to a certain extent.

Further, the repair items described above are given by way of examples. Addition of items of wheel replacement, steering replacement, seat replacement, replacement of shock absorbing devices (springs, shock absorbers, and the like), exhaust pipe (muffler) replacement, and acoustic system replacement is also possible.

It should be noted that, in addition to parts specified by the dealer or the main office, parts from the aftermarket may also be used for parts and the like needed for replacement. Further, as for part installation, the costs of parts may be added to the repair costs, and the main office or the dealer may advance the parts as leased items. In this case, another program is added in the vehicle provision support program described above. With the program, it is possible to make selection between installation of the parts as leased items and installation of the parts as purchased items. When a request of installation of the parts as leased items is accepted, a lease period for the parts and costs required for the lease are computed by the dealer terminal 1 or the like, and presented to the customer.

Further, as described above, the amount of working time for the repairs, the cost needed for the repairs according to the vehicle type, and the like are exemplified as information used as a judgement criterion for determining whether or not to make repairs. Those are only presented by way of example, however, and may be changed as desired. It should be noted that it is preferable to display information including the work time or the cost.

Further, although the vehicle provision support method according to the present invention is applied to the used car sales service in the description above, it is also possible to apply the vehicle provision support method to vehicle dealers, service centers, and the like, not only to used car dealers.

Further, although used cars are shown as examples of vehicles to which repairs are made in the above description, the vehicles to which repairs are made may also be vehicles in possession of the customer, not only used car. In this case, a mechanic at the service center performs the various repairs described above after the repair items are specified and the customer, or an employee of the dealer, brings the customer's vehicle to the service center. A value is newly added by the repairs in this case, and therefore the period of time during which the vehicle is held by the customer can be extended, and price stability can be achieved on the used car marketplace by controlling the amount of used cars supplied.

1. A vehicle provision support method for performing support using a computer to perform repairs on a vehicle and to provide the vehicle to a customer, comprising causing the computer to execute:
a step of presenting a plurality of repair items to the customer;
a step of accepting selection of repair items of repairs to be performed on the vehicle;
a step of outputting work items needed for the repairs, based on the repair items accepted;
a step of presenting information to the customer, before outputting the work items, the information being used as a judgment criterion for determining whether or not to make the repairs;
a step of accepting judgment which is made by the customer after receiving the information used as the judgment criterion; and
a step of determining whether or not to output the work items needed for the repairs, based on the judgment accepted.

2. A vehicle provision support method according to claim 1, wherein information that contains one of working time needed for the repairs and costs needed for the work is presented in the step of presenting the information used as the judgment criterion.

3. A vehicle provision support method according to claim 1, wherein the plurality of repair items are divided in advance into groups on a clientele basis and selection of the repair items is accepted with the group taken as a unit when accepting the selection of the repair items in the step of accepting the selection of the repair items.

4. A vehicle provision support method according to claim 1, wherein the repairs are performed and the repaired vehicle is delivered to the customer, the computer further executes: a step of acquiring a date on which the vehicle is delivered; a step of computing a fixed date after a predetermined period of time has passed from the vehicle delivery date as a warranty period expiration date; and a step of displaying the computed warranty period expiration date.

5. A vehicle provision support method according to claim 1, wherein:
the computer is connectable to a database capable of storing repair items accepted in the past and information on customers selecting the repair items in association with each other; and
when the step of presenting the repair items is performed for anew customer, the computer executes: a step of reading in information on the new customer; a step of extracting information on customers which is similar to the information of the new customer; and a step of presenting repair items to the new customer, the repair items being associated with the extracted customer information.

6. A vehicle provision support method according to claim 1, wherein when a part is to be installed in the vehicle during the repairs, the computer further executes: a step of accepting a judgment as to whether or not the part is to be installed as a leased item; and a step of computing and presenting costs needed for leasing the part when the part is to be installed as the leased item in the step of accepting the judgment.

7. A vehicle provision support program for causing a computer to execute support for performing repairs on a vehicle, and for providing the vehicle to a customer, the computer executing:
a step of presenting a plurality of repair items to the customer;
a step of accepting selection of repair items of repairs to be performed on the vehicle;
a step of outputting work items needed for the repairs, based on the repair items accepted;
a step of presenting information to the customer, before outputting the work items, the information being used as judgment criterion for determining whether or not to make the repairs;
a step of accepting judgment which is made by the customer after receiving the information used as the judgment criterion; and
a step of determining whether or not to output the work items needed for the repairs, based on the judgment accepted.

8. A vehicle provision support system for performing support to perform repairs on a vehicle and to provide the vehicle to a customer, comprising:
repair item presentation means for presenting a plurality of repair items of repairs to the customer;
repair item accepting means for accepting selection of repair of repairs to be performed to the vehicle;
work item outputting means for outputting work items needed for the repairs, based on the repair items accepted;
judgment criterion presentation means for presenting information to the customer, before outputting the work items, the information being used a judgment criterion for determining whether or not to make the repairs;
repair judgment accepting means for accepting judgment which is made by the customer after receiving the information used as the judgment criterion; and
output determination means for determining whether or not to output the work items needed for the repairs, based on the judgment accepted.
